(19) United States
(12) Patent Application Publication
(10) Pub. No.: US 2005/0246287 A1
(43) Pub. Date: Nov. 3, 2005

(54) Method for facilitating transaction of integrated circuit production among various parties through a network platform

(75) Inventor: Lawrence K. Lee, San Jose, CA (US)

Correspondence Address: Howard Chen;Preston Gates & Ellis LLP, Suite 1700, 55 Second Street, San Francisco, CA, 94105, US

(73) Assignee: Taiwan Semiconductor Manufacturing Co., Ltd.

(21) Appl. No.: 11/101,094

(22) Filed: Apr. 7, 2005

Related U.S. Application Data
(60) Provisional application No. 60/563,274, filed on Apr. 16, 2004.

(51) Int. Cl. H04K 1/00; H04L 9/00; G06F 17/60; H04L 12/66

(52) U.S. Cl. 705/59

(57) ABSTRACT

A business model implemented as a method or system facilitates transactions among a customer, IC manufacture service providers and IP providers. A network platform is used to receive a request for IP information from the customer. Upon approval of the request, the IP provider and the customer agree to a license agreement with respect to the terms of the customer's use of the IP information. Then, the IP information is delivered to the customer for purposes of producing and testing a prototype of the customer's IC design. The IP information for purposes of producing the prototype is free of charge or subject to insubstantial amount of charge. The customer is required to compensate the IP provider for its use of the IP information when it starts mass producing its IC designs.

### CROSS REFERENCE

The present application claims the benefits to U.S. Patent Provisional Application Ser. No. 60/563,274, which was filed on Apr. 16, 2004, and entitled “Business System and Methodology for IC Manufacturing and Prototype.”

### BACKGROUND

The present invention relates generally to processing transactions through the Internet, and more particularly to facilitating transitions of integrated circuit (IC) production among a consumer, intellectual property (IP) providers, and IC manufacture service providers.

The World Wide Web (“the Web”) is an interactive computer environment. The Web uses a collection of common protocols, such as the Hypertext Transfer Protocol (“HTTP”), and file formats, such as Hypertext Markup Language (“HTML”), to enable users to obtain information from or exchange information via the Internet. The amount of commerce being conducted on the Internet is exploding. Electronic commerce over the Internet has increased rapidly over the past few years. Many different types of commerce are transacted over the internet, and many different systems and methods have been implemented to carry out transactions. Both business to business (B2B) and business to consumer (B2C) transactions are increasingly popular due to the conveniences and benefits available through the use of the Internet.

In the semiconductor industry, a semiconductor IC chip, is produced after hundreds of process steps, such as a clean process, lithography process, ion implant process, chemical vapor deposition process, etc. Typically, the technology of producing the IC chip is developed by a team of process/manufacturing engineers and researchers in a semiconductor chip fabrication plant. The operation of such semiconductor chip fabrication plant requires a large amount of capital. Most of the IC design companies do not have their own fabrication plant. Instead of making the chips by themselves, they would use an IC manufacture service provider to produce IC chips according to their IC designs.

An IP provider provides IC design companies with certain IP information in support of their IC designs. By understanding the needs of the IC design companies, the IP provider can provide the solutions for their needs. Conventionally, the IP provider and IC design companies would go through a negotiation process to reach a licensing agreement with respect to certain IP information. The conventional means of communications for the negotiation includes telephones, e-mail or face-to-face discussion. The conventional communications means results in a lengthy negotiation processes and generates a substantial amount of paper work.

The IP information is not free of charge. The cost of acquiring the IP information is very expensive to the IC design companies and usually needs to be paid upfront in the development of the IC designs. Furthermore, an IC chip produced according to an IC design has to be verified to be sure that the chip functions properly. If the chip does not function properly, the IC manufacture service provider will need to redo the masks. This substantially incurs the costs of the chip production. Therefore, there is a high risk and entry barrier for both the IC design companies and IC manufacture service providers in producing IC chips.

As such, an improved transaction system and method is desired for reducing the transactional costs and risks for IC production.

### SUMMARY

This invention discloses a business model for facilitating a customer making a transaction with at least one intellectual property (IP) provider for an integrated circuit (IC) production project.

In one embodiment of the invention, a method is disclosed to carry out the business model. A network platform is used to receive a request for IP information from the customer. Upon approval of the request, the IP provider and the customer agree to a license agreement with respect to the terms of the customer's use of the IP information. Then, the IP information is delivered to the customer for purposes of producing and testing a prototype of the customer's IC design. The IP information for purposes of producing the prototype is free of charge or subject to insubstantial amount of charge. The customer is required to compensate the IP provider for its use of the IP information when it starts mass producing its IC designs.

### BRIEF DESCRIPTION OF THE DRAWINGS

FIG. 1 illustrates a relationship among a customer, at least one IP provider, and at least one IC manufacture service providers using a network platform in accordance with one embodiment of the present invention.

FIG. 2 illustrates a data structure of information stored in a platform for facilitating transactions among the customer, IP provider and IC manufacture service provider, in accordance with one embodiment of the present invention.

FIG. 3 illustrates a flowchart of a method for facilitating transactions among the customer, IP provider and IC manufacture service provider, in accordance with one embodiment of the present invention.

FIG. 4A presents a partial screen shot displaying a plurality of data variables in accordance with one embodiment of the present invention.

FIG. 4B presents a partial screen shot displaying a plurality of data variables in accordance with one embodiment of the present invention.

### DESCRIPTION

The present invention discloses a method for facilitating transactions among a customer, IC manufacture service providers and IP providers in producing IC chips. According to the method, a platform is used to receive a request for predetermined IP information from the customer, such as an IC design company, through the Internet. Upon approval of the request by the IP provider, IC manufacture service provider, or both, the IP provider and the customer agree to a predetermined license agreement with respect to the terms of the customer's use of the predetermined IP information. Then, the predetermined IP information is delivered to the customer for purposes of producing a prototype of the customer's IC design. The customer can test the prototype to verify whether its design is silicon proven, before mass production of the IC chips according to its design. The predetermined IP information for purposes of producing the prototype is free of charge or subject to insubstantial amount of charge. The customer is required to compensate the IP provider for its use of the predetermined IP information only when it starts mass producing its IC designs. This method significantly reduces the costs and risks for the customer in transactions with the IP provider and the IC manufacture service provider.

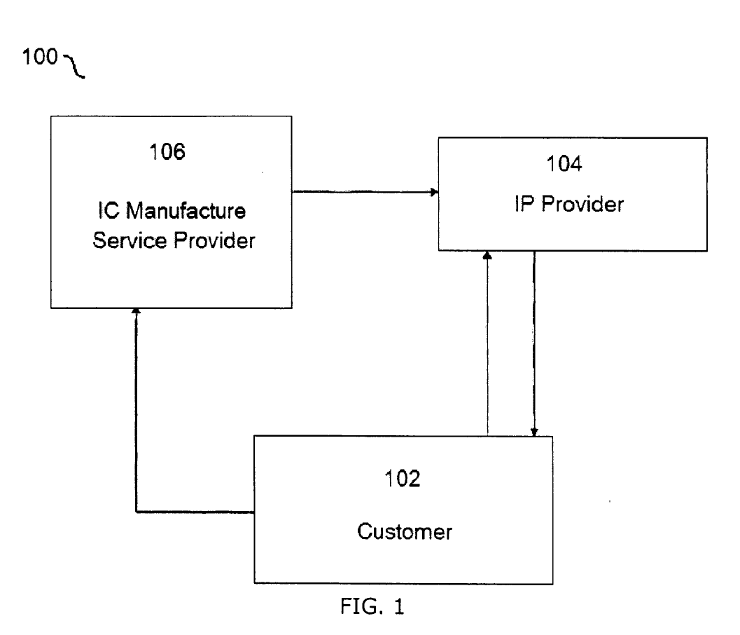

Referring to FIG. 1, a diagram 100 shows a business model among a customer 102, an IP provider 104 and an IC manufacture service provider 106 in accordance with one embodiment of the present invention. It is understood that the customer 102 may refer to one or more customers, the IP provider 104 may refer to one or more IP providers, and the IC manufacture service provider 106 may refer to one or more IC manufacture service providers. The customer 102 may be an IC design company that needs to acquire IP information from the IP provider 104 in support of its IC design development. Typically, the customer 102 has limited IC manufacture capacity, and acquires the service from the IC manufacture service provider 104 for producing IC chips according to its IC designs.

In this example, the IC manufacture service provider 106 provides a network platform that lists a number of IP providers 104 offering IP information for IC designs. The IC manufacturer is in the best position to be a “general contractor” to coordinate the complicated activities among different parties. The IC manufacture service provider 106 can actively promote the network platform, and encourages the customer 102 to make transactions with the IP provider 104 by using the network platform. The platform may provide a user interface for enabling the customer to submit a request for the predetermined IP information on-line and exchange other information with the IP provider 104. The user interface may be a set of table-based web pages. A representation of various inventories or hyperlinks can be displayed on a computer screen in the table-based format, with each cell representing a field of the service or information. Information can be entered using a cursor controller, such as a mouse, track ball or keyboard. It is noteworthy that while, in this embodiment, the network platform is provided by the IC manufacture service provider 106, it can be provided by the IP provider 104, or any third party.

The IP provider 104 plays the role of offering several aspects of IP information on the platform for the customer 106 to choose. It is suggested that the IP provider 104 and the IC manufacture service provider 108 agree a joint-marketing agreement with respect to the operation and promotion of the network platform. For example, once the IP provider 104 agrees to work with the IC manufacture service provider, it may not be able to refuse to work with the customers 106 of the IC manufacture service provider 108. That is, if a customer signs up with the IC manufacture service provider 108 using a predetermined agreement, the IP provider may not withdraw from the arrangement except for some exceptional situations. For instance, the IP provider 104 may not want to provide its IP to a competitor or to induce a competitive relation with certain party. Similarly, it can be arranged that if the customer 106 decides to use the platform organized by the IC manufacture service provider 108, it may enter into an exclusive relation with the selected platform. The IC manufacture service provider 108 may appoints an account manager to maintain the platform and collect requests for the predetermined IP information from the customer 102. If the account manager, IP provider 104, or both approve an initial request by the customer 102, the IP provider 104 will deliver the requested predetermined IP information to the customer 102 for purposes of producing a prototype, upon that the customer 102 agrees to a standard license agreement. The license agreement may be simplified as opposed to a full-blown version of license agreement that usually results in a lengthy negotiation between the IP provider 104 and customer 102 due to the prior relationship between the IP provider 104 and the IC manufacture service provider 106. This significantly reduces the time required and paper work generated in a negotiation according to a conventional transaction module. It is noteworthy that while, in this embodiment, the account manager is appointed by the IC manufacture service provider 108, he or she may be appointed by the IP provider 104 or any third party.

According to the license agreement, the predetermined IP information for purposes of producing a prototype of the customer's IC design is free of charge or subject to insubstantial amount of charge. Of course, the customer's use of the IP information has to comply with the terms and confidential restrictions of the license agreement. Under the license agreement, the customer 102 has no obligation to buy, or to pay anything upfront. The customer 102 may negotiate with the IP provider 104 in advance or in parallel and only pay for a production license after its IC design is silicon proven. The customer 102 can use the predetermined IP information for its IC designs. The IC manufacture service provider 106 supports the customer 102 to turn its designs into IC prototypes. In other words, the customer 102 is not required to substantially compensate the IP provider 104 for the predetermined IP information until the mass production of the customer's IC designs.

The platform used to carry out the above described business model may include a processor, data storage medium, user interface, and Internet accessing means. The data storage medium is used for storing information related to services provided by the IP provider, the IC manufacture service provider, or both. The user interface is capable of receiving a request for predetermined IP information selected from the information stored in the data storage medium through the Internet. The received request is processed by the processor and presented to the IP provider, the IC manufacture service provider, or both for approval.

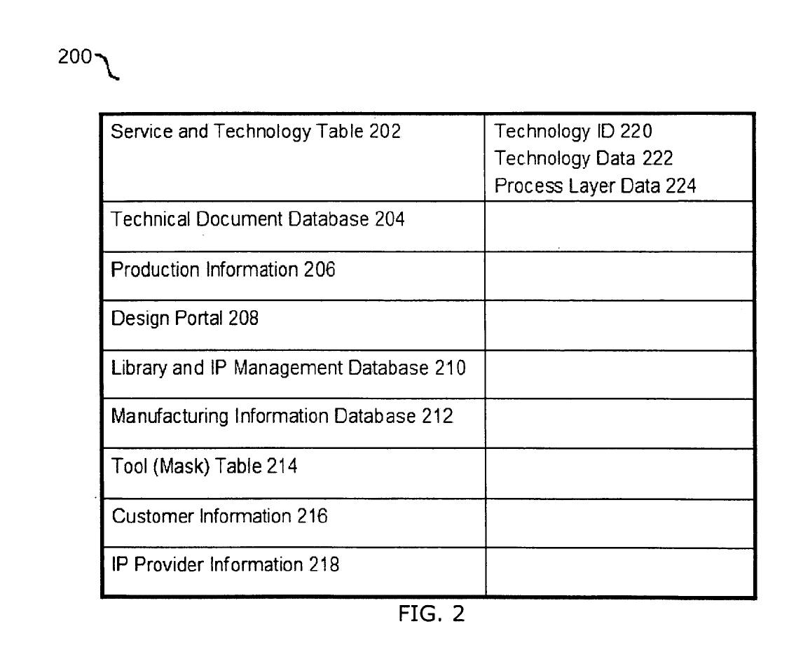

FIG. 2 illustrates a data structure of the information stored in the storage medium. A diagram 200 illustrates the data structure of the information stored in the data storage medium in accordance with one embodiment of the present invention. The data structure contains one or more inter-linked tables, which are categorized into a service and technology (S&T) table 202, a technical document database 204, a set of production information 206, a design portal 208, a library and IP management database 210, a manufacturing information database 212, a tool (mask) table 214, a set of customer information 216, and a set of IP provider information 218. Each major function of the S&T table 202, the set of production information 206, and the tool (mask) table 214 is divided into several functional subcategories for further specifying the product technology.

To further illustrate the invention, the tool (mask) table 214 is a list of masks typically used in fabricating a particular product in a semiconductor process. The customer information 216 holds information such as a customer code, a customer name, and communication information, all of which are understood to be sortable and arrangable by columns. The S&T table 202 records the product technology used by a specific product, and includes subcategories, such as a technology ID number 220 for identifying the product technology used by the product, a set of technology data 222 for recording the product technology used in the fabrication of the product, and a set of process layer data 224 for recording the information of each process layer. The set of production information 206 records the production related information, while the IP management database 210 contains all of the transaction information.

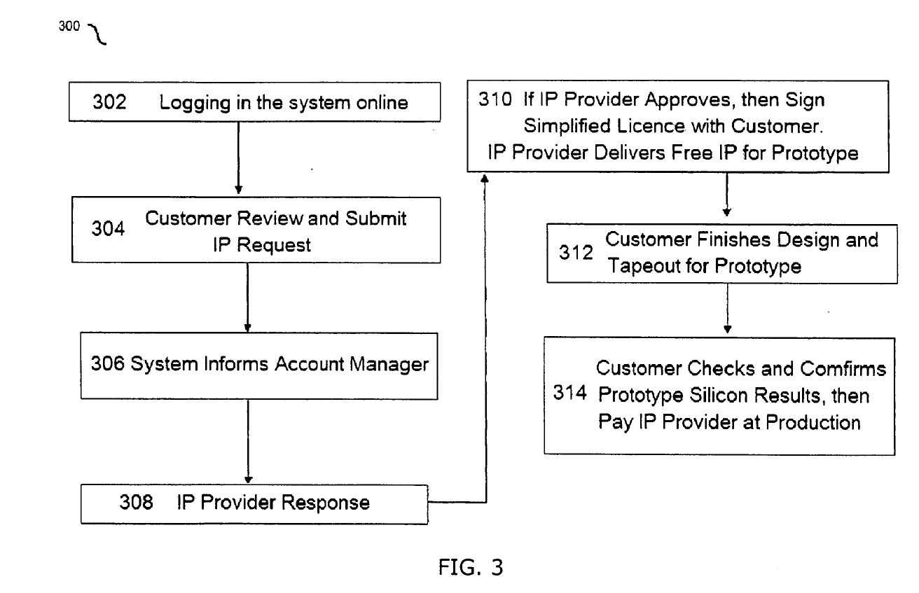

FIG. 3 illustrates a flowchart 300 of using the business model to make transactions among the customer, IP provider and IC manufacture service provider, in accordance with one embodiment of the present invention. In step 302, the customer initiates a transaction by logging into the platform through the Internet. The platform will verify the user ID and password provided by the customer. The customer then reviews and submits an IP request through the Internet in step 304. The customer would select an appropriate IP provider depending on its needs. Some examples of specialties by different IP providers can be technologies such as embedded processors, analog Phase Lock Loop synthesizer, specialty Input/Output modules, various application modules, standard-based cores, etc. The system will inform the account manager, who is usually appointed by the IC manufacture service provider, for preliminary approval in step 306. If approved, the system will inform the IP provider. In step 308, the IP provider responds within a certain time period, such as within 24 hours. The account manger is authorized by the IC manufacture service provider to determine an approved volume of the prototype. This prevents the customer from ordering a too large volume of the prototype, and therefore improperly taking advantages of the business model.

Until this point, the transaction flow is in pre-approval stage. If the IP provider approves, a final approval will be entered into the platform, and the transaction flow moves to a post-approval stage. Then, a simplified license or other types of agreements are signed by the customer in step 310 before the IP provider delivers the requested IP information for prototype. The customer is free of charge or subject to insubstantial amount of charge at this stage. After the customer finishes it IC designs and the IC manufacture service provider produces the prototype of its IC design in step 312, the customer can check and confirm the prototype's silicon results in step 314. If the customer is satisfied with the prototype and decides to start the mass production, the customer will now be required to pay the IP provider for the requested IP information in step 314.

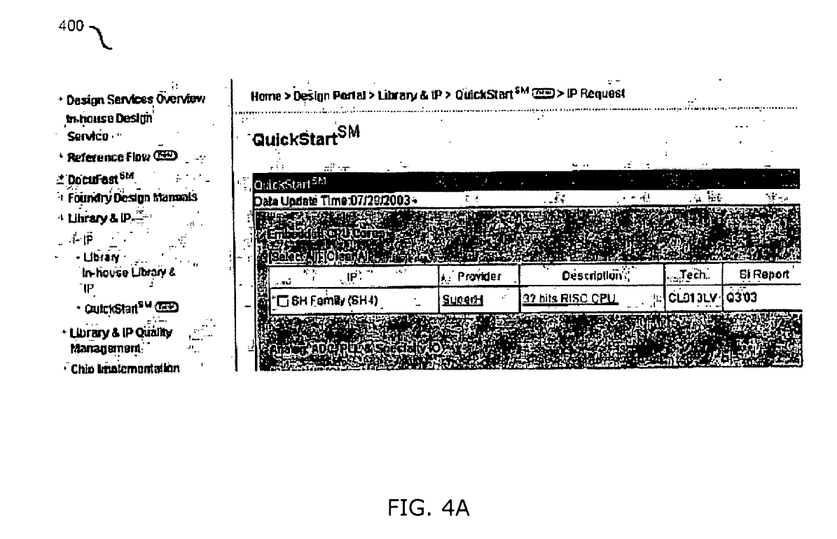

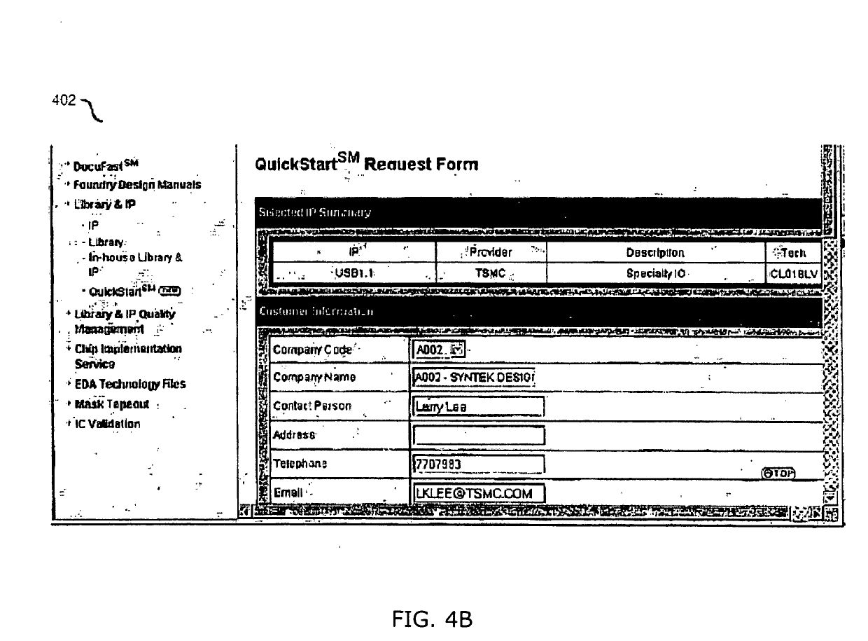

FIG. 4A presents a partial screen shot 400 displaying a plurality of data variables provided by the platform in accordance with one embodiment of the present invention. It is understood that the screen shot 400 is merely an example, and that the arrangement or the layout of the items displayed therein may be changed without deviating from the spirit of this invention. The screen shot 400 shows a user interface screen where user can choose from a selection menu located on the left side of the screen. The selection menu is shown to contain various criteria and conditions included in the S&T table. On the right side of the screen, an IP provider can be requested through the Internet. Information such as IP provider, ID number and the description of a product can be located on screens similar to the screen presented in the screen shot 400. The IP provider ID number records which IP is used for a product technology, and the descriptions of product and technology are also provided.

FIG. 4B presents a partial screen shot 402 displaying a plurality of data variables in accordance with one embodiment of the present invention. The screen shot 402 shows a user interface screen where user can choose from a selection menu located on the left side of the screen. It is understood that the selection menu contains various criteria and conditions included in the S&T table. On the right side of the screen, customer information such as company name, individual name, address, phone number, email, and etc. can be keyed in.

It is understood that the spatial arrangements of various items may be changed without deviating from the spirit of the invention. For example, the user interface can further include several items with blank spaces for typing in critical information relevant to a specific product technology. According to embodiments of the present invention, the items can be arranged to include information such as design rules, IP provider ID number, product type, technology descriptions, and much more.

This invention provides a business model carried out in a computer network for facilitating transactions among any number of customers, IC manufacture service providers and IP providers. The computer network is well suited to lower the transactional risk especially for small design companies in that they can be sure to have a silicon-proven prototype without the obligation of a substantial compensation of licensing certain IP information before moving a product line into mass production. This system also creates other advantages, including more design-ins, lock-ins, lower risk strategies, shorter time-to-volume, and shorter time-to-revenue.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. A method for facilitating a customer making a transaction with at least one intellectual property (IP) provider for an integrated circuit (IC) production project, comprising:
submitting by the customer a request for obtaining predetermined IP information needed for an IC design to a network platform, the platform providing a list of IP providers for choice;
fulfilling the request by at least one of the IP providers that provides the predetermined IP information;
producing a prototype of the IC design of the customer using the predetermined IP information; and
mass producing the IC design by an IC manufacture service provider upon approving the prototype,
wherein the customer is free of charge or subject to an insubstantial amount of charge for the predetermined IP information used for purposes of producing the prototype prior to mass producing the IC design.

2. The method of claim 1 wherein the request submitted is handled by an account manager appointed by the IC manufacture service provider.

3. The method of claim 2 wherein the fulfilling further comprises approving the request by the account manger before the IP provider accepts the request.

4. The method of claim 2 wherein the account manger is authorized by the IC manufacture service provider to determine an approved volume of the prototype.

5. The method of claim 1 wherein the fulfilling further comprises accepting, by the customer, a simplified license agreement with regard to the predetermined IP information before the same is delivered.

6. The method of claim 1 wherein the mass producing further includes confirming that the prototype is silicon proven by the customer.

7. The method of claim 1 further comprising compensating the IP provider by the customer for the predetermined IP information upon the mass production of the IC design.

8. A platform for facilitating a customer making a transaction with at least one intellectual property (IP) provider for an integrated circuit (IC) production project, comprising:
a processor;
a data storage medium for storing information related to services provided by the IP provider; and
a user interface for receiving a request for predetermined IP information selected from the information stored in the data storage medium through a network connection, the request being processed by the processor and presented to the IP provider for approval,
wherein upon the approval of the request, the IP provider is required to deliver the IP information to the customer for purposes of producing a prototype of an IC design of the customer free of charge or subject to an insubstantial amount of charge.

9. The platform of claim 8 wherein the request is handled by an account manager appointed by an IC manufacture service provider.

10. The platform of claim 9 wherein the request is processed and presented to the account manager for approval before the same is presented to the IP provider.

11. The platform of claim 8 wherein the data storage medium further comprises information related to services provided by the IC manufacture service provider.

12. The platform of claim 11 wherein the information stored in the data storage medium is structured into categories including service and technology tables, production information, design portal, library and IP management database, manufacturing information database, customer information, and IP provider information.

13. The platform of claim 12 wherein the service and technology tables are further structured into subcategories including technology identifications, technology data, and process layer data.

14. A method for facilitating a customer making a transaction with at least one intellectual property (IP) provider and at least one integrated circuit (IC) manufacture service provider for an integrated circuit (IC) design project through an internet platform, the method comprising:
submitting a request for predetermined IP information to a platform providing a list of the IP providers participating in the platform;
approving the request by the account manger appointed by the IC manufacture service provider;
approving the request by at least one IP provider that provides the predetermined IP information for generating a prototype of the IC design;
providing the predetermined IP information to the customer; and
producing a prototype of the IC design utilizing the predetermined IP information by the IC manufacture service provider,
wherein the customer is free of charge or subject to an insubstantial amount of charge for the predetermined IP information used for purposes of producing the prototype.

15. The method of claim 14 wherein the account manger is authorized by the IC manufacture service provider to determine an approved volume of the prototype.

16. The method of claim 14 wherein the customer and the IP provider agree to a simplified license agreement with regard to the predetermined IP information before the same is delivered to the customer.

17. The method of claim 14 further comprising a step of confirming that the prototype is silicon proven by the customer.

18. The method of claim 17 further comprising a step of mass producing the IC design by the IC manufacture service provider.

19. The method of claim 18 wherein the customer compensates the IP provider for the predetermined IP information upon the mass production of the IC design.
